(19) United States
(12) Patent Application Publication
(10) Pub. No.: US 2009/0282215 A1
(43) Pub. Date: Nov. 12, 2009

(54) MULTI-PROCESSOR SYSTEM AND MULTI-PROCESSING METHOD IN MULTI-PROCESSOR SYSTEM

(75) Inventors: Moo Kyoung CHUNG, Daejeon (KR); Seong Hyun Cho, Daejeon (KR); Kyung Su Kim, Seoul (KR); Jae Jin Lee, Chungbuk (KR); Jun Young Lee, Busan (KR); Seong Mo Park, Daejeon (KR); Nak Woong Eum, Daejeon (KR)

Correspondence Address: RABIN & Berdo, PC, 1101 14TH STREET, NW, SUITE 500, WASHINGTON, DC, 20005, US

(73) Assignee: ELECTRONICS AND TELECOMMUNICATIONS RESEARCH INSTITUTE, Daejeon (KR)

(21) Appl. No.: 12/346,803

(22) Filed: Dec. 30, 2008

(30) Foreign Application Priority Data
May 9, 2008 (KR) 10-2008-0043605

(51) Int. Cl. G06F 15/76; G06F 9/02

(52) U.S. Cl. 712/29; 712/E09.002

(57) ABSTRACT

Provided are a multi-processor system and a multi-processing method in the multi-processor system. The multi-processor system comprises a plurality of processors each including a data core and a processing core; and switches connecting the data core to the processing core in each of the processors as a combination of a data core-processing core pair. Therefore, the multi-processor system may be useful to remove any overhead for communications and make programming easy and simple.

### CROSS-REFERENCE TO RELATED APPLICATIONS

This application claims the priority of Korean Patent Application No. 2008-43605 filed on May 9, 2008, in the Korean Intellectual Property Office, the disclosure of which is incorporated herein by reference.

### BACKGROUND OF THE INVENTION

1. Field of the Invention

The present invention relates to a multi-processor system, and more particularly, to a multi-processor system capable of removing any overhead for communications and making programming easy and simple, and a multi-processing method in the multi-processor system.

2. Description of the Related Art

In systems including a multi-processor, it is necessary to communicate between processors in order to interlock several processor cores. In particular, applications having frequent communications between processors or a large amount of data to be transmitted should effectively perform communications in order to improve performances of the multi-processor system.

Structures of the multi-processor system used for communications between processors may be mainly divided into a hierarchical memory structure and a connection structure connecting memories to processors. Various techniques regarding these structures have been widely known and applied in the art.

As alternatives to transfer data from one processor to another processor, the following two methods have been widely used in the multi-processor system. Among them, one method is to write data on a memory shared by two processors, and the other method is to transfer data from one processor to another processor through channels that directly or indirectly connect the processors to each other

However, these two methods have the problems in that the methods have long latency and require additional programming works.

Furthermore, the multi-processor system has the problems in that its programming is more complicated than in the use of a single processor, and it is difficult to effectively perform a parallel operation on several processors, which leads to an increase in manufacturing costs.

### SUMMARY OF THE INVENTION

The present invention is designed to solve the problems of the prior art, and therefore it is an object of the present invention to provide a multi-processor system capable of removing any overhead for communications and making programming easy and simple.

Also, it is another object of the present invention to provide a multi-processing method in the multi-processor system.

A data core is defined as a storage-related part in the single processor, and includes a register, a load/store unit, a data cache, etc.

A processing core is defined as a control and processing-related part in the single processor, and includes a control unit, an execution unit, an instruction cache, etc.

According to an aspect of the present invention, there is provided a multi-processor system including a plurality of processors each including a data core and a processing core; and switches connecting the data core and the processing core to each other to form a combination of a data core-processing core pair, the data core and the processing core being included in each of the processors.

According to another aspect of the present invention, there is provided a multi-processing method in the multi-processor system. The multi-processing method includes sequentially connecting the processing cores to data cores; processing data transmitted to the data cores sequentially connected to the processing cores; storing the corresponding process propagate data in a process propagate data memory of the data cores newly connected to the processing cores; and storing data required for processing the data of the data cores newly connected to the processing cores.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a diagram illustrating a configuration of a processor in a processor system.

FIG. 2 is a diagram illustrating a configuration of a multi-processor system according to one exemplary embodiment of the present invention.

FIG. 3 is a diagram illustrating an order of virtual applications according to one exemplary embodiment of the present invention.

FIG. 4 is a diagram illustrating a sequential connection of data cores and processing cores in the use of the virtual applications as shown in FIG. 3.

FIG. 5 is a diagram illustrating a pipelined flow of programs and data in the use of the virtual applications as shown in FIG. 3.

FIG. 6 is a diagram illustrating program pseudo codes of the virtual applications according to one exemplary embodiment of the present invention.

### DETAILED DESCRIPTION OF THE PREFERRED EMBODIMENT

Exemplary embodiments of the present invention will now be described in detail with reference to the accompanying drawings. For the exemplary embodiments of the present invention, detailed descriptions of known functions and constructions that are related to the present invention are omitted for clarity when they are unnecessarily proven to make the gist of the present invention unnecessarily confusing.

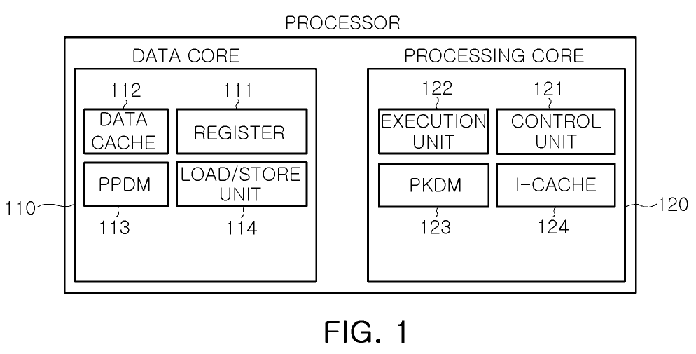

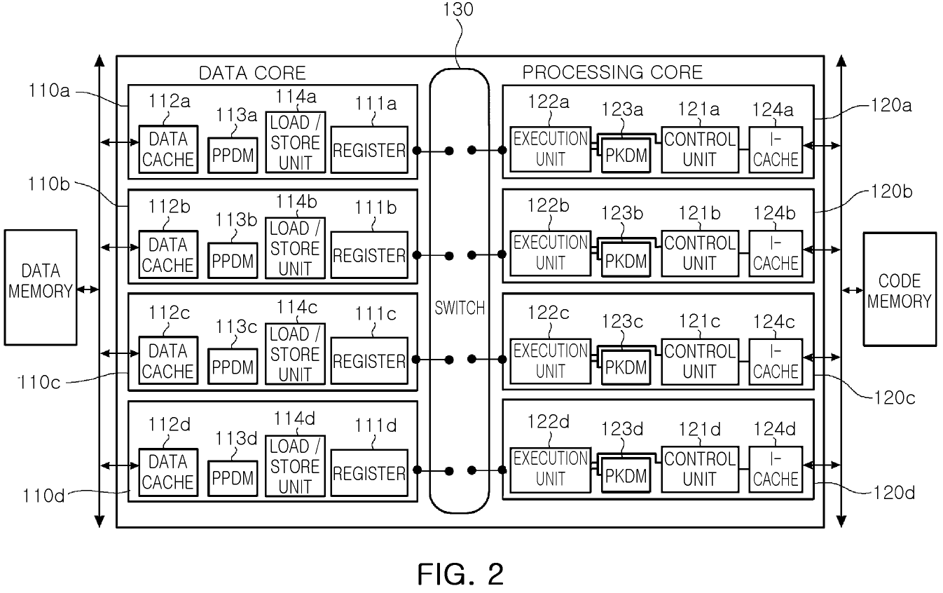

FIG. 1 is a diagram illustrating a configuration of a processor in a processor system, and FIG. 2 is a diagram illustrating a configuration of a multi-processor system according to one exemplary embodiment of the present invention.

Referring to FIGS. 1 and 2, the multi-processor system according to one exemplary embodiment of the present invention includes a plurality of processors, and each of the processors includes a data core 110(110a˜110d) and a processing core 120 (120a˜120d). Also, the multi-processor system includes switches 130 exchangeably connecting a processing core 120 in one processor to a data core 110 in another processor.

The data core 110(110a˜110d) includes a register 111(111a˜111d) for storing data of a processor, a data cache 112 (112a˜111d) for caching the data of the processor, a process propagate data memory (hereinafter, referring to ‘PPDM’) 113 (113a˜113d) and a load/store unit 114 (114a˜114d). Here, the PPDM 113 (113a˜113d) is a memory of the data core 110 (110a˜110d) and independently stores a process propagation data that are intermediate data associated only with processing of corresponding data during a process for processing specific data. For example, the data core 110a stores data, which should be continuously present during a process for sequentially connecting one data core to the processing cores 120 (120a˜120d), in PPDM 113a. The load/store unit 114(114a˜114d) is connected the register 111(111a˜111d) and the process propagate data memory 113 (113a˜113d) to load/store the data of a processor or the process propagation data.

The processing core 120 (120a˜120d) includes a control unit 121 (121a˜121d) for processing insturctions, an execution unit 122(121a˜121d) connected to the control unit 121(121a˜121d) to perform an operation, a process keep data memory (hereinafter, referred to as ‘PKDM’) 123(123a˜123d), and an instruction cache 124 (124a˜124d) for caching the content of an external instruction memory. Here, the PKDM 123 (123a˜123d) is a memory of the processing core 120 (120a˜120d) that stores data required for a specific processing operation.

The switch 130 functions to connect the data cores 110 and the processing cores 120 to form an arbitrary combination of a data core-processing core pairs. The switch 130 receives switching commands from each of the processing cores 120. In this case, the switch 130 may sequentially connect the data cores 110 and the processing cores 120 to each other in a predetermined order. Alternately the switch 130 may sequentially connect the data cores 110 and the processing cores 120 to each other in an arbitrary order according to the switching commands. The sequential connection between the processing cores 120 and data cores 110 may be changed in real time by allowing a processing cores 120 in one processor to assign a data core 110 in the next processor. In this switching process, the communications between the processing cores 120 may be performed without additional overhead. For example, when two processing cores 120 are connected respectively to data cores 110 by exchanging the data cores 110 with each other through a switching operation, the two processing cores 120 have such an effect as to exchange the entire data without any transfer of data between the two processing cores 120. That is to say, the communications between the processors are performed without additional overhead, for example, by connecting one data core, which has been connected to one processing core 120a, to another processing core 120b. In order to receive commands from the processors, each of the switches 130 may include a register in a specific region on a memory map of the processor, and be assigned to switch a register for the specific purpose of the processing core 120.

4 processors, each of which is composed of a pair of a data core 110 and a process core 120 as shown in FIG. 2, simultaneously perform different processing operations on 4 data sequentially entering the data cores 110a to 110d.

Since the 4 processors process continuously incoming data streams at the same time, some problems may occur when intermediate data obtained by processing specific data and intermediate data of different process cores are stored together in the same memory space. In order to solve this problem, some memory regions of each of the processors should be separated from each other.

The PPDM 113a˜113d is used to solve the above problem. For example, the data core 110a stores the process propagation data that are intermediate data associated only with processing of specific data during a process for processing the specific data. In this case, the process propagation data are stored independently in PPDM 113a of the data core 110a.

On the contrary, data associated with a specific processing core may be shared like a program code since the data are not changed according to the data stream. However, when these data get frequent access to the processing core, performances of the processing core may be deteriorated due to continuous access to the long-latency shared memories. Therefore, the frequently accessed data associated with the specific processing core are stored in the PKDM 123a to 123d, which leads to improved performances of the multi-processor system.

The multi-processor system configured thus is suitable for applications in the form of data flow such multimedia data processing. One virtual example of these applications will be described in detail with reference to the accompanying drawings.

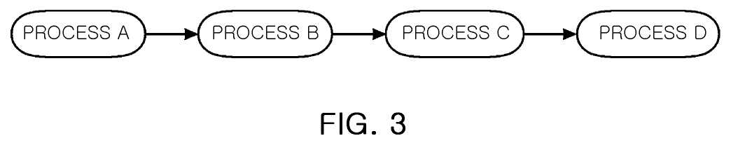

The applications process continuous stream data in the form of data flow through processes A, B, C and D, as shown in FIG. 3. When the processing of the applications is applied to the multi-processor system according to one exemplary embodiment of the present invention, the multi-processor system form 4 processors, that is, 4 pairs of data cores 110a to 110d and processing cores 120a to 120d, as shown in FIG. 2, in order to perform an operation of the processes A, B, C and D. Here, each of the 4 processing cores 120a to 120d performs the operation of the processes A, B, C and D. The processing cores 120a to 120d share the data processing, and the data transfer between the processing cores is performed by transferring the data cores.

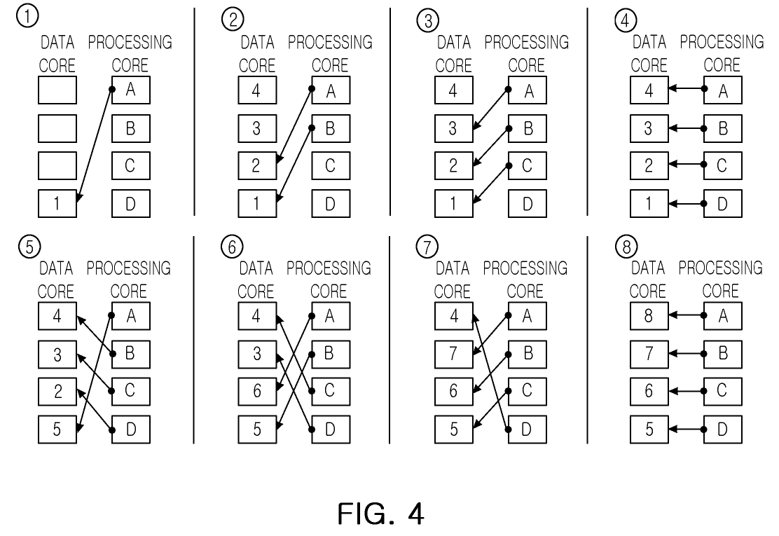

For example, when 8 data sets (1 to 8) are processed through processes A, B, C and D, the data cores 110a to 110d may be sequentially connected respectively to the processing cores 120a to 120d through the switches 130, as shown in FIG. 4. Here, the processes A, B, C and D function as pipelines. Therefore, the entire ‘throughput’ is reduced by ¼ when compared to that of the single processor, and the 4 processors may be used in the best effective manner, as shown in FIG. 2.

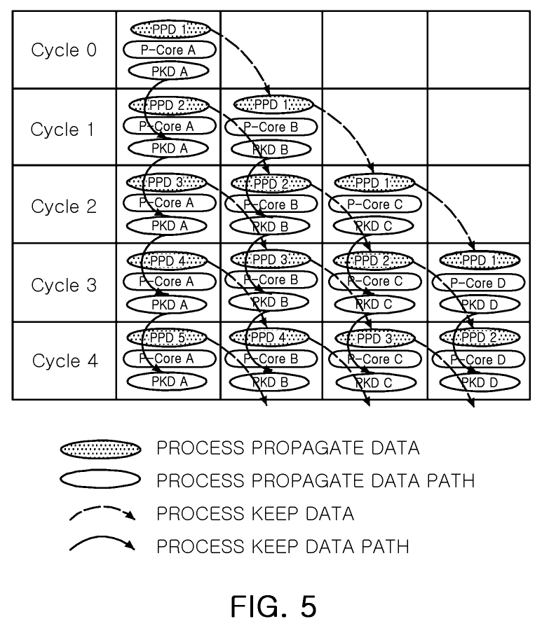

Then, a pipelined flow of programs and data in the use of the virtual application as shown in FIG. 3 will be described in more detail with reference to FIG. 5.

In the first cycle (cycle 0), an operation of process A as shown in FIG. 3 is performed. Here, a first processing core (P-Core A) 120a is connected to a first data core 110a to form a first processing core-first data core pair. Then, the first processing core 120a processes sequentially incoming data, that is, a first data. In this case, intermediate data associated only with the processing of the corresponding data are stored in a first PPDM 113a of a first data core 110a. These stored data are referred to as “process propagate data (PPD).” And, process keep data (PKD A) that are frequently accessed data associated with process A are stored in the first PKDM 123a of the first processing core 120a.

In the second cycle (cycle 1), processes A and B are performed. Here, the first processing core (P-Core A) 120a is connected to a second data core 110b to form a first processing core-second data core pair, and a second processing core (P-Core B) 120b is connected to the first data core 110a to form a second processing core-first data core pair. In this case, PPD 1 that is an intermediate data associated only with the processing of data of process A in the first cycle (cycle 0) is transferred to processor B, and processed in the second processing core 120b. Therefore, frequently incoming data (PKD B) associated with an operation of process B are stored in a second PKDM 123b of a second processing core 120b. Meanwhile, the first processing core 120a processes the data inputted into the second data core 110b to store PPD 2, which are intermediate data associated only with the data processing, in the second PPDM 113b and store the frequently accessed data (PKD A) associated with the operation of process A in the first PKDM 123a.

In a third cycle (cycle 2), processes A, B and C are performed. Here, the first processing core (P-Core A) 120a is connected to a third data core 110c to form a first processing core-third data core pair, the second processing core (P-Core B) 120b is connected to the second data core 110b to form a second processing core-second data core pair, and a third processing core (P-Core C) 120c is connected to the first data core 110a to form a third processing core-first data core pair.

The PPD 1 in the second cycle (cycle 1) is transferred to an operation of process C, and then processed in the third processing core 120c. The PPD 2 in the second cycle (cycle 1) is transferred to an operation of process B, and then processed in the second processing core 120b. Therefore, PKD C are stored in the third PKDM 123c of the third processing core 120c, and the PKD B are stored in the second PKDM 120b of the second processing core 120c. Meanwhile, the first processing core 120a processes the data inputted into the third data core 110c to store the PPD 3 in the third PPDM 113c, and store the PKD A in the first PKDM 123a.

In a fourth cycle (cycle 3), processes A, B, C and D are performed. Here, the first processing core (P-Core A) 120a is connected to a fourth data core 110d to form a first processing core-fourth data core pair, the second processing core (P-Core B) 120b is connected to the third data core 110c to form a second processing core-third data core pair, the third processing core (P-Core C) 120c is connected to the second data core 110b to form a third processing core-second data core pair, and a fourth processing core (P-Core D) 120d is connected to the first data core 110a to form a fourth processing core-first data core pair.

The PPD 1 in the third cycle (cycle 2) is transferred to an operation of process D, and then processed in the fourth processing core 120d. The PPD 2 in the third cycle (cycle 2) is transferred to an operation of process C, and then processed in the third processing core 120c. The PPD3 in the third cycle (cycle 2) is processed in the second processing core 120b. Therefore, PKD D is stored in the fourth PKDM 123d of the fourth processing core 120d, PKD C is stored in the third PKDM 123c of the third processing core 120c, and PKD B is stored in the second PKDM 123b of the second processing core 120b. Meanwhile, the first processing core 120a processes the data inputted into the fourth data core 110d to store PPD 4 in the fourth PPDM 113d.

Similarly, it may be revealed that PPD 5 to PPD 1 are stored in the corresponding PPDMs 113 and PKDs are stored in corresponding PKDMs 123 in a fifth cycle (cycle 4) in the same manner as described above, as shown in FIG. 5.

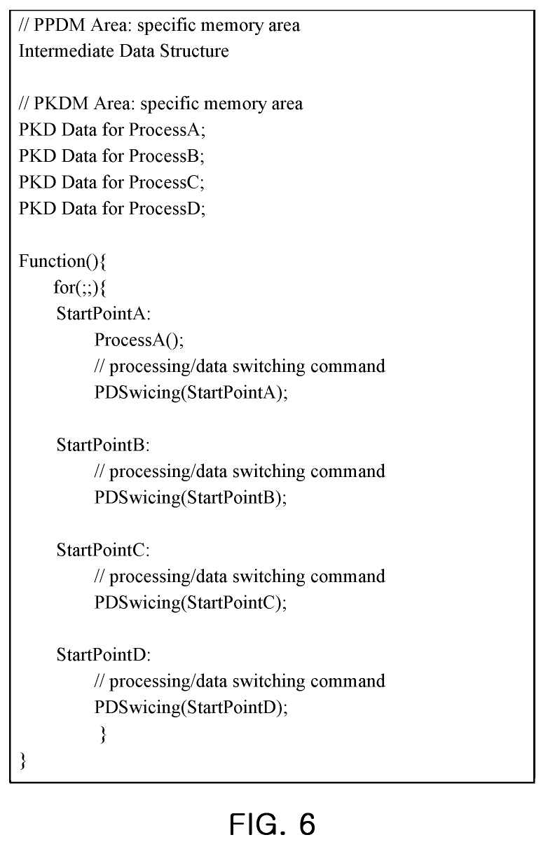

The multi-processor may be easily programmed according to the above-mentioned multi-processor system according to one exemplary embodiment of the present invention. Here, FIG. 6 shows a pseudo code in the programming of a multi-processor. This multi-processor program is performed by adding only 2 program codes to the original single processor program. As shown in FIG. 6, one of the program code is to declare data stored in PPDMs and PKDMs and assign the data that, and the other is to add switching commands to regions where processes A, B, C and D are separated.

Meanwhile, the data cores are not prepared in time since processing time in the operations of the processes is not regular in the one exemplary embodiment of the present invention, and therefore the processing cores may frequently wait, or its reverse operation may occur. When load balancing is not suitably made according to characteristics of data to be processed, the switch according to one exemplary embodiment of the present invention may shut down a waiting data core or processing core. Also, when this load is checked in an algorithm in advance, load balancing between processing cores may be made while being realized with low power consumption using a power and frequency scaling method. That is to say, the switches according to one exemplary embodiment of the present invention is suitable for use in low-power techniques such as clock gating, frequency scaling, power shutdown, voltage scaling, etc. Therefore, the above-mentioned multi-processor system according to one exemplary embodiment of the present invention may achieve a significant effect on a low-power design.

The multi-processor system according to the present invention is useful to remove any overhead for communications since the communications in the multi-processor system is performed in one processing/data switching process. The multi-processor system is useful to achieve effects of a multi-processor with the use of a single processor by adding two parts to the single processor program, the two parts being composed of a switching command and data definition that will be stored in PPDMs and PKDMs.

While the present invention has been shown and described in connection with the exemplary embodiments, it will be apparent to those skilled in the art that modifications and variations can be made without departing from the spirit and scope of the invention as defined by the appended claims. Therefore, it should be understood that the scope of the present invention is not designed to limit the exemplary embodiments of the present invention, but is construed as being the appended claims and equivalents thereof.

What is claimed is:

1. A multi-processor system, comprising
a plurality of processors each including a data core and a processing core; and
switches connecting the data core to the processing core to form a combination of a data core-processing core pair, the data core and the processing core being included in each of the processors.

2. The multi-processor system of claim 1, wherein the data core comprises:
a register storing data of processor;
a data cache for caching the data;
a process propagate data memory (PPDM) independently storing process propagation data that are intermediate data associated only with processing of specific data during a process for processing the specific data; and
a load/store unit connected with the register and a data memory to load/store the data of processor or the process propagate data.

3. The multi-processor system of claim 1, wherein the processing core comprises:
an execution unit for performing a processing operation;
a control unit connected to the execution unit to process instructions;
an instruction cache for caching the content of an external instruction memory; and
a process keep data memory (PKDM) storing data required for a specific processing operation.

4. The multi-processor system of claim 3, wherein the process keep data memory (PKDM) is a memory of the processing core that stores frequently accessed data associated only with the processing core comprising the PKDM.

5. The multi-processor system of claim 1, wherein the switches receive switching commands from the respective processing cores and sequentially connect the respective processing cores to the corresponding data cores in a predetermined order.

6. The multi-processor system of claim 1, wherein the switches receive switching commands from the respective processing cores and sequentially connect the respective processing cores to the corresponding data cores in an arbitrary order.

7. The multi-processor system of claim 1, wherein the switches connect the respective processing cores, respectively, to data cores which are assigned by the respective processing cores in real time.

8. A multi-processing method in the multi-processor system, comprising:
connecting processing cores to data cores to form a combination of a data core-processing core pair, the processing cores and data cores being included in a plurality of processors;
processing data that are inputted through the processing cores to the data cores;
storing process propagate data in a process propagate data memory included in the data core connected to the processing core, the process propagate data being an intermediate data associated with the processing of the data; and
storing data, which is required for processing of the data, in a process keep data memory (PKDM) in the processing cores.

9. The multi-processing method of claim 8, further comprising:
sequentially connecting the processing cores to data cores;
processing data transmitted to the data cores sequentially connected to the processing cores;
storing the corresponding process propagate data in a process propagate data memory of the data cores newly connected to the processing cores; and
storing data required for processing the data of the data cores newly connected to the processing cores.
